(19) United States
(12) Patent Application Publication
(10) Pub. No.: US 2024/0286307 A1
(43) Pub. Date: Aug. 29, 2024

(54) FILM FOR APPLICATION TO PRESSURIZED BODIES AND METHOD FOR THE PRODUCTION THEREOF

(71) Applicant: LUFTHANSA TECHNIK AG, Hamburg (DE)

(72) Inventors: Dirk TROTTNOW, Sahms (DE); Marcin GIERSZEWSKI, Hamburg (DE)

(21) Appl. No.: 18/693,531

(22) PCT Filed: Sep. 9, 2022
(86) PCT No.: PCT/EP2022/075116

§ 371 Date: Mar. 20, 2024

(30) Foreign Application Priority Data
Sep. 20, 2021 (DE) 10 2021 124 182.0

(51) Int. Cl. B26F 1/18; B64C 1/12

(52) U.S. Cl. CPC B26F 1/18; B64C 1/12

(57) ABSTRACT

The invention relates to a film (1) for application to pressurized bodies (20) and to a method for the production thereof. The film (1) according to the invention is distinguished by a slotted perforation (10) consisting of slots (11) in a planar arrangement and also without release of material. In order to produce such a slotted perforation (10), a perforation roller cutter (40) inserted into a cutting plotter (30) can be guided linearly over and into an unperforated film.

### CROSS REFERENCE TO RELATED APPLICATIONS

This application is a U.S. National Phase application under 35 U.S.C. § 371 of International Application No. PCT/EP2022/075116, filed on Sep. 9, 2022, and claims benefit to German Patent Application No. DE 10 2021 124 182.0, filed on Sep. 20, 2021. The International Application was published in German on Mar. 23, 2023 as WO 2023/041434 A1 under PCT Article 21(2).

### FIELD

The present disclosure relates to a film for application to pressurized bodies, in particular fuselages of aircraft with pressurized cabins, and to a method for its production.

### BACKGROUND

The bonding of bodies to permanently or temporarily change their appearance is widely known in the prior art. For example, the outer skin of cars or buses can be covered with plastic film in sections or over large areas in order to mark the vehicles in a special way or to provide them with advertising. The plastic film can be printed and/or cut to any shape.

The covering with film is also known in the field of aviation, especially commercial aviation. Films are used there, for example, to temporarily cover the fuselage of an aircraft with advertising slogans or special designs. The covering is usually much more cost-effective than changing the actual paintwork of an aircraft for such purposes, even in certain areas.

Particularly on the fuselage of commercial aircrafts, which are regularly designed as pressurized cabins, minor air leakage can occur on the outer skin during operation. The so-called air leaks are basically leaks in the shell of the pressurized fuselage.

If a continuous film is arranged in the area of an air outlet on the outside of an aircraft fuselage, an air balloon effect can occur in principle, in which the air outlet leads to an area-by-area detachment and the formation of an air bubble in the film.

To avoid or at least significantly reduce this, it is known in the prior art to provide the film with a regular pattern of punched holes. If such a film extends over an air outlet, a possible partial detachment of the film only extends as far as one of the punched holes, as the air from the air outlet can escape through this hole and then no longer collects between the outer skin and the film.

In the prior art, when punching the holes of the regular pattern, material is removed from the film in the desired shape of the holes-often circular-by machines specially designed for this purpose. The punching residues or punching slugs are always extracted immediately. However, unclean punching, e.g. due to blurred punching tools, can also cause the punching residue to remain attached to the film and cannot be removed by suction. Such punching residues may then be removed manually.

The punching of holes in the film also results in a large number of open adhesive edges after the film has been applied, i.e. areas where the adhesion of the film is exposed at the sides. Dirt regularly adheres to these adhesive edges, which can spoil the appearance of films with light colors in particular. The color of the application surface can also shine through the holes, which can also be detrimental to the appearance of the film.

Last but not least, the aerodynamic quality of the outer skin of an aircraft deteriorates due to the punched-out holes or the removal of material in these areas compared to a smooth surface.

### SUMMARY

In an embodiment, the present disclosure provides a film for application to pressurized bodies, the film comprising: a slotted perforation consisting of slots arranged over a flat area without material release.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 a schematic representation of a film according to embodiments of the disclosure;

FIG. 2 a schematic detailed representation of the film from FIG. 1 applied to a pressurized body, according to embodiments of the disclosure;

FIG. 3 a schematic representation of the production of the film from FIG. 1, according to embodiments of the disclosure; and

FIG. 4 a detailed view of the perforation roller cutter used in the production according to FIG. 3, according to embodiments of the disclosure.

### DETAILED DESCRIPTION

In accordance with an embodiment, the present disclosure describes creating a film for application to pressurized bodies, such as aircraft fuselages, in which the disadvantages known from the prior art no longer occur or occur only to a reduced extent. In accordance with another embodiment, the present disclosure provides a method for the production of such a film.

Accordingly, the present disclosure provides a film for application to pressurized bodies, which has a slotted perforation consisting of slots arranged over a flat surface without material release.

Furthermore, in accordance with an embodiment, the present disclosure provides a method for the production of such a film according to the present disclosure, in which the slotted perforation is introduced line by line into an unperforated film using a perforation roller cutter inserted into a cutting plotter.

First, some terms used in connection with the present disclosure are explained.

“Slots without material removal” is a perforation of a film in which the film is pierced—for example with a cutting edge-in such a way that the film is no longer continuous in the area of the slot, but at the same time no material is actually removed from the film. In contrast to punching or die-cutting, no actual recess is created, but only a perforation in the film.

A “two-dimensional assembly” of elements, in this case slots, is an assembly of elements extending over a surface, i.e. two-dimensional in relation to the surface.

The present disclosure has recognized that in the case of films for application to pressurized bodies, the provision of a slotted perforation consisting of slots arranged over a large area without material release is sufficient to guide possible air discharges on the outside of the pressurized body through the film and thus avoid large-area detachment of the film and formation of (larger) air bubbles. If an air outlet occurs in the area of the film away from a slot, an air channel is formed between the outer skin of the body and the film-comparable to known films with punched holes-only between the air outlet and a nearby slot. The air then expands the slots in question and can flow out through them.

Away from air outlets, the film lies flat against the outside of the pressurized body and—as there is no material release-results in a practically continuous surface without exposed adhesive edges, even in the areas of the slots. In particular, the disadvantages associated with the material recesses of punched holes from the prior art can thus be largely avoided. Depending on the elasticity of the film, the slots that have widened due to escaping air can also close again as soon as air is no longer escaping, so that the original appearance of the film can also be achieved in these areas, at least at times when the body is not pressurized.

In accordance with another embodiment, the film can be produced simply and inexpensively from an unperforated film using a cutting plotter and may not require a separate punching machine or—in view of the absence of material release—an extraction system or the like.

In some embodiments, it is preferred if the slots of the flat slotted perforation are arranged in several parallel lines. An assembly of the slots in parallel lines enables a particularly simple and cost-effective production of the film according to the present disclosure.

The slots of the flat slotted perforation can have a constant length, a constant direction and/or a constant distance. When the slots are arranged in parallel lines, the said constant distance can refer to the distance between two neighboring slots on the same line and/or the distance between two neighboring lines.

In some embodiments, the slots of the slotted perforation each have a length of 0 mm to 2 mm, preferably of 0.5 mm to 1.5 mm, more preferably of 1 mm. The slots of the slotted perforation can have a distance between them of 5 mm to 15 mm, preferably 7 mm to 13 mm, more preferably 10 mm.

In addition, the film can be designed like known films for covering bodies and in particular have an adhesive layer to be self-adhesive. The adhesive layer can preferably be suitable for dry and/or wet bonding, whereby the slotted perforation provided according to the present disclosure promotes drying in the case of wet bonding.

It is also possible for the adhesive layer to include air channels running in the plane of the adhesive layer. On the one hand, these air channels serve to “smooth out” any air bubbles when applying the film to a surface. However, they can also be used to guide the air between an air outlet and a nearby slot, so that no or only a short air channel may have to be formed in the case of an air outlet so that the air can escape through the film. The design of the air channels may be such that the adhesion of the film for the respective application may be guaranteed.

If the film is used for its intended purpose, the result is an assembly composed of a film according to the present disclosure and a pressurized body, the film being applied, in particular glued, to the pressurized body. The pressurized body can preferably be the fuselage of an aircraft with a pressurized cabin, preferably a commercial aircraft. In the case of aircraft, the application of film for at least temporary design of the outer skin is in principle well known. At the same time, there is also the problem of air leaks in the area of corresponding applied films, which is advantageously addressed by the film according to the present disclosure.

The film according to the present disclosure can be produced particularly easily and cost-effectively if the slotted perforation is introduced line by line into an unperforated film using a perforation roller cutter inserted into a cutting plotter. In particular, the cutting plotter can be a flatbed cutting plotter.

Even if it may be possible in principle to create the slotted perforation according to the present disclosure with an ordinary cutting head of a cutting plotter, in particular comprising a tangential knife, but possibly also comprising a drag knife, this would be very time-consuming due to the frequent lifting and lowering of the knife which may be absolutely necessary and would possibly even result in considerable wear of the plotter mechanism. Even if a corresponding production with the claimed film as such is not fundamentally excluded, the production method according to the present disclosure provides for introducing the desired slotted perforation line by line into an unperforated film using a perforation roller cutter inserted into a cutting plotter. A corresponding perforation roller cutter is characterized by a gear-like design in which a “tooth” serves as a cutting edge to create a slot with a length and orientation defined by the tooth width, and the “tooth space” defines the distance between two adjacent slots. To create a linear assembly of slots, a corresponding perforation roller cutter only needs to be lowered once onto the film by the cutting head of a cutting plotter and then guided along the desired line across the film. As the perforation roller cutter rotates through contact with the film or through a separate drive, the teeth and the spaces between the teeth of the perforation roller cutter alternately come into contact with the film and thus create the desired spaced slots. At the end of a linear assembly, the cutting blade is raised again and lowered again at the beginning of another desired linear assembly of slots. This makes it possible to create a film with a slotted perforation according to the present disclosure quickly and without having to resort to special machines, using slots arranged over a wide area without material release.

In principle, it is possible to print and/or cut the film to a desired shape before or after inserting the slotted perforation according to the present disclosure. In some embodiments, however, any printing or cutting takes place before the slotted perforation is inserted. It has been shown that subsequent printing cannot guarantee an optimal print image; if the cutting knife is guided through a previously created slot when cutting the film, there is a risk of the film tearing at this slot.

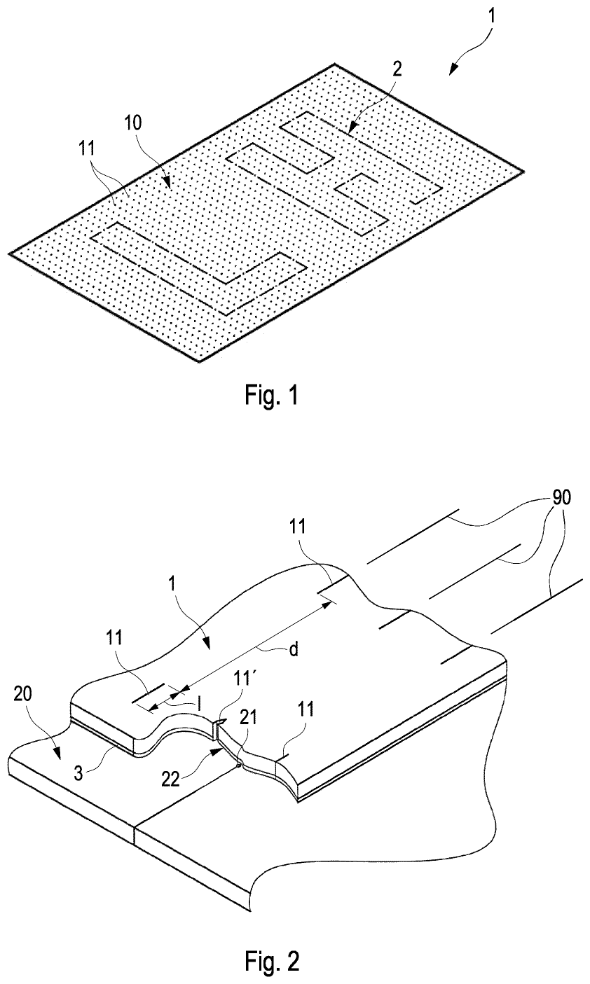

FIG. 1 shows an example of a film 1 according to the present disclosure, the detailed structure of which is illustrated in particular in FIG. 2.

The film 1 is a highly elastic and stretchable plastic film with a colored print 2 on one side, the main contours of which are indicated by dotted lines in FIG. 1. On the other side, the film 1 has an adhesive layer 3, which makes the film 1 self-adhesive. The adhesive layer 3 is designed to be suitable for application of the film 1 according to the known wet bonding process.

The film 1 is provided with a slotted perforation 10 consisting of flat slots 11 without material release. The design and assembly of the individual slots 11 can be seen in particular in FIG. 2, where a small area of the slotted perforation 10 is shown. However, the pattern shown there continues throughout film 1.

The individual slots 11 are arranged along several parallel lines 90, which are schematically indicated in FIG. 2. The lines 90 are at a constant distance from each other.

Along the lines 90, the slots 11 are each aligned identically—namely parallel to the respective line 90—and each have a length 1 of 1 mm and a distance d of 10 mm from one another.

The slots 11 are each created without material release, so that although the structure of the film 1 is interrupted by the slots 11, the film 1 in the normal state, in which the slots 11 are not particularly widened, e.g., still forms a flat surface without actual recesses, even across the slots 11.

The film 1 can be applied to the outside of a pressurized body 20 using a known wet bonding process, as shown schematically in FIG. 2. The pressurized body 20 can in particular be the fuselage of an aircraft with a pressurized cabin, e.g. a commercial aircraft.

In the exemplary illustration, the body 20 is actually pressurized. On an aircraft with a pressurized cabin, e.g., this is always the case during the cruise flight. In the present exemplary embodiment, an air outlet 21 is to be present in the area of the outer skin of the body 20 in which the film 1 is applied, through which air escapes from the body 20.

The air escaping under pressure seeks a path between the outer skin of the body 20 and the film 1 up to a slot 11′-possibly by localized detachment of the film 1 or its adhesive layer 3. In other words, the escaping air forms an air channel 22 between the body 20 and the film 1, which leads from the air outlet 20 to a nearby slot 11′.

As the film is perforated in the area of the slots 11, air can escape through the slots 11. For this purpose—as indicated in FIG. 2 for slot 11′—slot 11′ is widened by the escaping air. If the film is sufficiently elastic, a correspondingly widened slot 11′ closes again completely as soon as air no longer escapes, e.g. because the body is no longer pressurized.

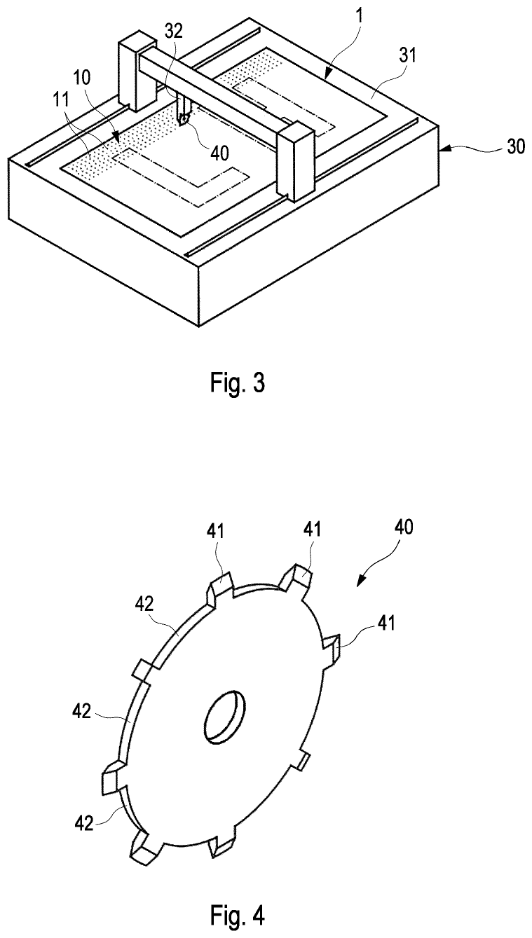

FIG. 3 sketches the production of the film shown in FIGS. 1 and 2.

The already fully printed film is laid out on the table 31 of a flatbed cutting plotter 30. A perforation roller cutter 40, which is shown in detail in FIG. 4, is arranged on the plotter head 32, which can be moved in two axes over the table 31 of the cutting plotter 30.

The perforation roller cutter 40 is a roller cutter in which the cutting edge is not continuous, but rather comprises uniform cutting segments 41 spaced apart from one another in a gear-like manner and uniformly distributed over the circumference, with cutting edge-free areas 42 in between. By unrolling the perforation roller cutter 40 on a film 1, a slot perforation is thus created along the roll path without material release, in which the length 1 of the slots 11 created (see FIG. 2) corresponds to the length of the cutting segments 41 and the distances d between two slots 11 (see FIG. 2) correspond to the length of the areas 42 without cutting.

To create the slotted perforation 10 from slots 11 arranged in a flatbed, the perforation roller cutter 40 is guided by the flatbed cutting plotter 30 in parallel lines over the film 1 in such a way that the perforation roller cutter 40 rolls on the film 1. As a result, the cutting segments 41 cut slots 11 into the film at regular distances along the respective line. Once all the intended parallel lines 90 have been traversed by the cutting plotter 30, the film 1 has the slotted perforation 10 shown in FIG. 1 consisting of slots 11 arranged over the entire surface without material release.

The method described for the production of a film 1 according to the present disclosure can also be carried out with film previously cut by the cutting plotter 30 in a known manner, e.g. with a drag or tangential knife. In the case of appropriately cut films, only the actual film is regularly cut through, but not the backing paper, so that the insertion of a slotted perforation 10, as described, is still possible without any problems.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A film for application to pressurized bodies, the film comprising:
a slotted perforation consisting of slots arranged over a flat area without material release.

2. The film according to claim 1, wherein
the slots of the slotted perforation are arranged in several parallel lines.

3. The film according to claim 1, wherein
the slots of the slotted perforation have a constant length, a constant direction and/or a constant distance.

4. The film according to claim 1, wherein
the slots of the slotted perforation each have a length of 0 mm to 2 mm.

5. The film according to claim 1, wherein
the slots of the slotted perforation have a distance between them of 5 mm to 15 mm.

6. The film according to claim 1, wherein
the film further comprises an adhesive layer so as to be self-adhesive.

7. The film according to claim 6, wherein
the adhesive layer comprises air channels extending in a plane of the adhesive layer.

8. An assembly of a film according to claim 1 and a pressurized body, comprising:
the film being applied to the pressurized body.

9. The assembly according to claim 8, wherein
the pressurized body is a fuselage of an aircraft with a pressurized cabin.

10. A method for production of the film according to claim 1, the method comprising:
introducing the slotted perforation line by line into an unperforated film using a perforation roller cutter inserted in a cutting plotter.

11. The method according to claim 10, wherein
the cutting plotter is a flatbed cutting plotter.

12. The film according to claim 4, wherein the slots of the slotted perforation each have a length of 0.5 mm to 1.5 mm.

13. The film according to claim 12, wherein the slots of the slotted perforation each have a length of 1 mm.

14. The film according to claim 5, wherein the slots of the slotted perforation have a distance between them of 7 mm to 13 mm.

15. The film according to claim 14, wherein the slots of the slotted perforation have a distance of 10 mm.

16. The film according to claim 6, wherein the adhesive layer is suitable for dry and/or wet bonding.
